(19) United States
(12) Patent Application Publication
(10) Pub. No.: US 2014/0375591 A1
(43) Pub. Date: Dec. 25, 2014

(54) TOUCH SCREEN AND APPARATUS OF DRIVING THE SAME

(71) Applicant: HIMAX TECHNOLOGIES LIMITED, Tainan City (TW)

(72) Inventors: Yaw-Guang Chang, Tainan City (TW); Wei-Song Wang, Tainan City (TW); Chang-Hui Lin, Tainan City (TW)

(73) Assignee: HIMAX TECHNOLOGIES LIMITED

(21) Appl. No.: 13/921,759

(22) Filed: Jun. 19, 2013

(51) Int. Cl. G06F 3/044

(52) U.S. Cl. CPC G06F 3/044
USPC 345/174

(57) ABSTRACT

In apparatus of driving a touch screen, a transmitter (TX) driving unit generates TX driving signals coupled to a TX electrode substrate, and receiver (RX) detection signals are then induced on an RX electrode substrate that is coupled to and detected by an RX detection unit. A plurality of the TX driving signals are simultaneously generated and fed to the TX electrode substrate, and the TX driving signals during a given period have different phases, respectively.

### BACKGROUND OF THE INVENTION

1. Field of the Invention

The present invention generally relates to a touch screen, and more particularly to apparatus of simultaneously driving multiple signals in a touch screen.

2. Description of Related Art

A touch screen is an input/output device that combines touch technology and display technology to enable users to directly interact with what is displayed. FIG. 1 shows waveforms of driving signals conventionally used to drive a touch screen. Specifically, during period t₀ to t₃, while a first electrode line associated with a driving signal TX1 is driven, other electrode lines (e.g., a second and a third electrode lines associated with driving signals TX2 and TX3) should be waited. In the same manner, the second electrode line is driven during period t₃ to t₆, and the third electrode line is driven during period t₆ to t₉. Therefore, a large amount of time from t₀ to t₉ is needed to complete driving three electrode lines.

It is worth noting that the conventional driving scheme demonstrated above cannot be adapted to an advanced touch screen with bigger panel size and/or larger resolution for the reason that a signal processor cannot complete driving and detection in time without detection loss.

Some schemes have been proposed to accelerate the driving, for example, by simultaneously driving multiple electrode lines. However, most schemes incur sharp increase in their overall value, thereby resulting in increasing the complexity of detection.

For the foregoing reasons, a need has arisen to propose a novel scheme to increase driving speed without adverse effect.

### SUMMARY OF THE INVENTION

In view of the foregoing, it is an object of the embodiment of the present invention to provide apparatus of driving a touch screen to substantially increase the driving speed without incurring sharp increase in DC value.

According to one embodiment, a touch screen includes a transmitter (TX) electrode substrate, a TX driving unit, a receiver (RX) electrode substrate and an RX detection unit. The TX driving unit is configured to generate TX driving signals coupled to the TX electrode substrate. RX detection signals are then induced on the RX electrode substrate due to the TX driving signals. The RX detection unit is configured to detect the RX detection signals. A plurality of the TX driving signals are simultaneously generated and fed to the TX electrode substrate, and the TX driving signals during a given period have different phases, respectively.

### BRIEF DESCRIPTION OF THE DRAWINGS

FIG. 1 shows waveforms of driving signals conventionally used to drive a touch screen;

FIG. 2 shows a schematic diagram illustrating apparatus of driving a touch screen according to one embodiment of the present invention;

FIG. 3A schematically shows an example illustrative of driving the touch screen according to one embodiment of the present invention;

FIG. 3B shows exemplary phases and DC values of FIG. 3A;

FIG. 3C shows another example of phases and DC values; and

FIG. 4 schematically shows a circuit of generating a TX driving signal.

### DETAILED DESCRIPTION OF THE INVENTION

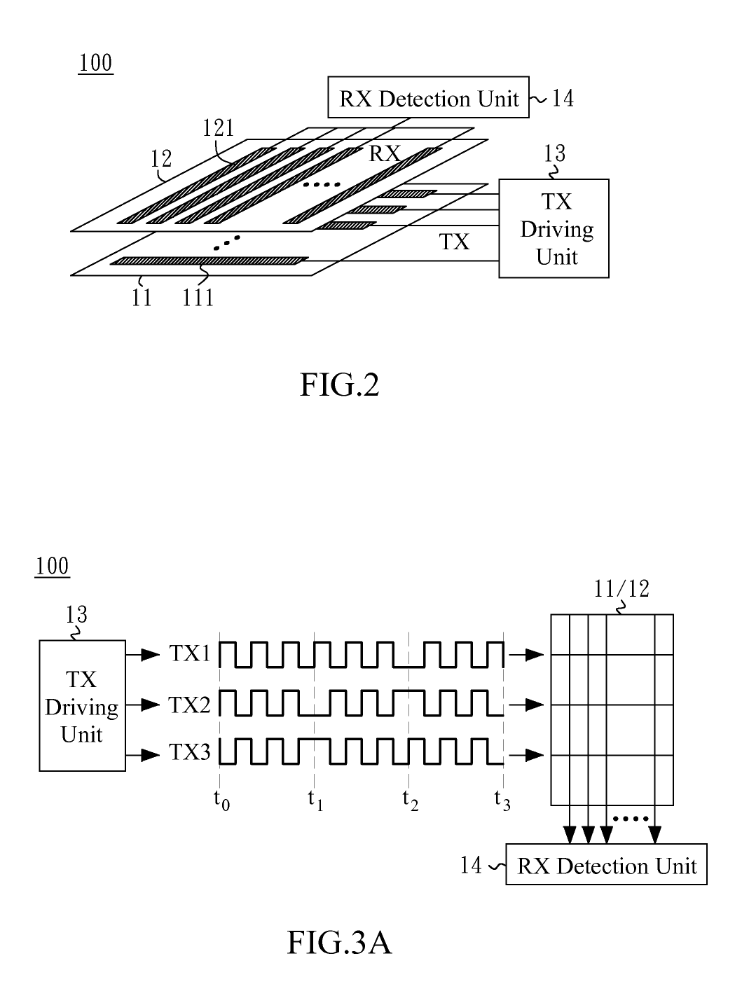

FIG. 2 shows a schematic diagram illustrating apparatus of driving a touch screen 100 according to one embodiment of the present invention. The touch screen 100 may, but not necessarily, be an in-cell touch screen that is an electronic visual display with sensing electrode layers disposed within a liquid crystal module (LCM). For better understanding the embodiment, only touch portion of the touch screen 100 is shown in FIG. 2. In the embodiment, the touch screen 100 includes a transmitter (TX) electrode substrate 11, which is patterned with a plurality of TX electrode lines 111 that are disposed substantially parallel to each other. Although line-shaped TX electrode lines 111 are exemplified in FIG. 2, the TX electrode lines 111 may have other shape such as rhombus. The touch screen 100 also includes a receiver (RX) electrode substrate 12 patterned with a plurality of RX electrode lines 121 that are disposed substantially parallel to each other. Although line-shaped RX electrode lines 1221 are exemplified in FIG. 2, the RX electrode lines 121 may have other shape such as rhombus. The TX electrode lines 111 may, but not necessarily, be substantially perpendicular to the RX electrode lines 121.

As shown in FIG. 2, the TX electrode lines 111 are coupled to respectively receive TX driving signals from a TX driving unit 13. An RX detection unit 14 is coupled to receive RX detection, signals from the RX electrode lines 121, respectively. The RX detection signals are induced by capacitances between the TX electrode lines 111 and the RX electrode lines 121, and the capacitances may be affected, for example, by a finger touched above the RX electrode substrate 12. Therefore, the induced RX detection signal with affected capacitance may then be used, in companion with the driven TX electrode line, to determine the touched position.

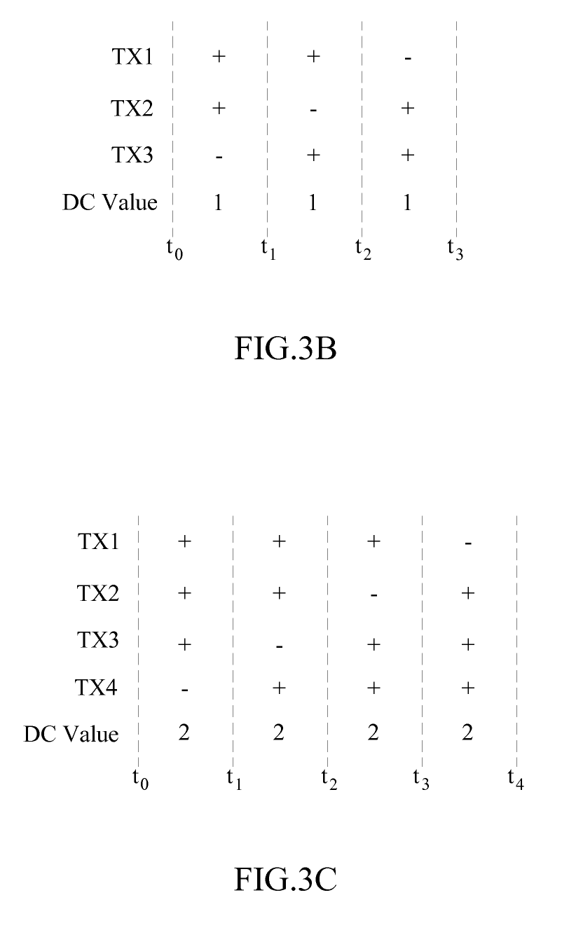

FIG. 3A schematically shows an example illustrative of driving the touch screen 100 according to one embodiment of the present invention. In the embodiment, a plurality (e.g., 3 as exemplified in FIG. 3A) of TX driving signals are simultaneously generated and fed to corresponding TX electrode lines, respectively, which need not be adjacent to each other.

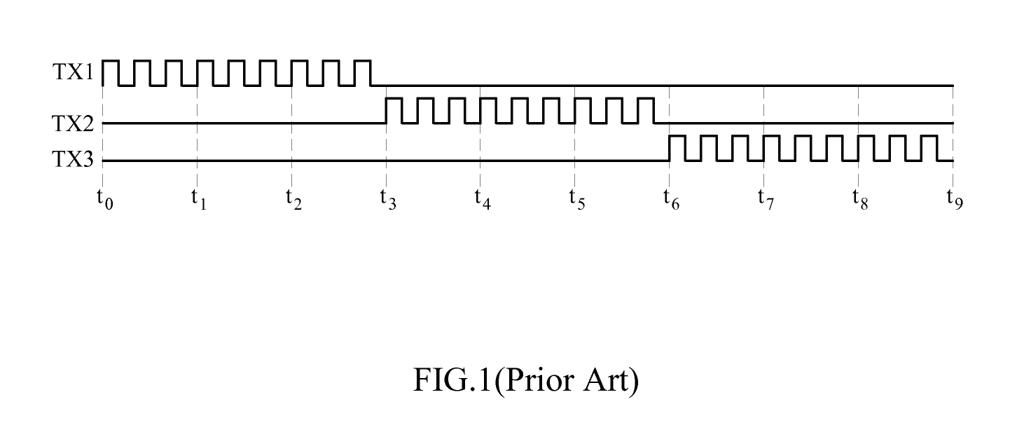

According to one aspect of the embodiment, as exemplified in FIG. 3B with odd number of TX driving signals, the TX driving signals during a given period (e.g., t₉₀ to t₁) have different phases. For example, during the period between t₀ and t₁, the first TX driving signal TX1 has a positive phase (+), the second TX driving signal TX2 has a positive phase (+), and the third TX driving signal TX3 has a negative phase (−). As a result, an overall (or effective) direct-current (DC) value (e.g., 1) of the TX driving signals during a given period will not incur a sharp increase. Compared with conventional driving scheme as shown in FIG. 1, the driving scheme of the embodiment (FIG. 3A and FIG. 3B) can maintain the same DC value while increasing driving speed three times. FIG. 3C shows another example with even number of TX driving signals. Similar to the result shown in FIG. 3B, an overall (or effective) direct-current (DC) value (e.g., 2) of the TX driving signals during a given period will not incur a sharp increase.

According to another aspect of the embodiment, the TX driving signals of all periods have the same overall DC value. As exemplified in FIG. 3B, the TX driving signals of all periods have the same DC value of 1. Moreover, in the embodiment, the TX driving signals of each period have a non-zero (i.e., either positive or negative) overall DC value.

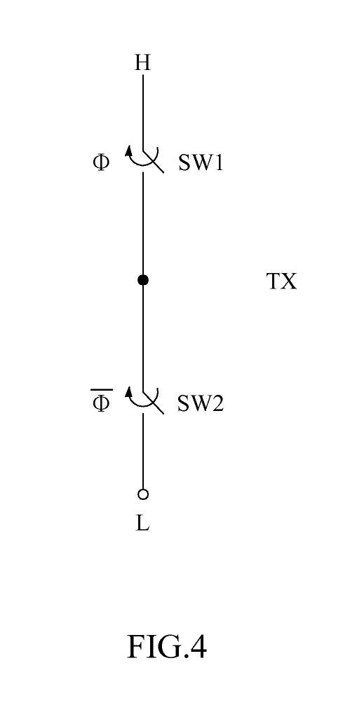

The TX driving signal of the embodiment may be generated by using a variety of circuit design technique. For example, as schematically shown in FIG. 4, the TX driving signal with a positive phase may be obtained by alternately coupling to a high voltage (H) and a low voltage (L) via switches SW1 and SW2, respectively, which are controlled by switching control signals φ and inverted φ, respectively. A TX driving signal with a negative phase may be obtained by interchanging the switching control signals φ and inverted φ; or be obtained by inverting the TX driving signal with the positive phase, for example, by an inverter. It is appreciated that the high voltage (H) and/or the low voltage (L) may be further derived, for example, by a pump circuit, from a voltage with less magnitude.

According to the embodiment described above, the driving speed may be substantially increased without incurring sharp increase in DC value.

Although specific embodiments have been illustrated and described, it will be appreciated by those skilled in the art that various modifications may be made without departing from the scope of the present invention, which is intended to be limited solely by the appended claims.

What is claimed is:

1. Apparatus of driving a touch screen, which comprises a transmitter (TX) electrode substrate and a receiver (RX) electrode substrate, the apparatus comprising:
a TX driving unit configured to generate TX driving signals coupled to the TX electrode substrate, RX detection signals being then induced on the RX electrode substrate that is coupled to and detected by an RX detection unit;
wherein a plurality of the TX driving signals are simultaneously generated and fed to the TX electrode substrate, and the TX driving signals during a given period have different phases, respectively.

2. The apparatus of claim 1, wherein the TX electrode substrate is patterned with a plurality of TX electrode lines coupled to receive the TX driving signals.

3. The apparatus of claim 2, wherein the RX electrode substrate is patterned with a plurality of RX electrode lines coupled to the RX detection unit.

4. The apparatus of claim 1, wherein the TX driving signals of all periods have a same overall DC value.

5. The apparatus of claim 1, wherein the TX driving signals of each period have a non-zero overall DC value.

6. The apparatus of claim 1, wherein the TX driving unit comprises:
means for coupling to a high voltage;
means for coupling to a low voltage;
a first switch, via which the high voltage is controllably outputted as the TX driving signal; and
a second switch, via which the low voltage is controllably outputted as the TX driving signal;
wherein the first switch and the second switch are controlled by a switching control signal and an inverted switching control signal, respectively, such that the TX driving signal is obtained by alternately coupling to the high voltage and the low voltage via the first switch and the second switch, respectively.

7. A touch screen, comprising:
a transmitter (TX) electrode substrate;
a TX driving unit configured to generate TX driving signals coupled to the TX electrode substrate;
a receiver (RX) electrode substrate, on which RX detection signals being then induced due to the TX driving signals; and
an RX detection unit configured to detect the RX detection signals;
wherein a plurality of the TX driving signals are simultaneously generated and fed to the TX electrode substrate, and the TX driving signals during a given period have different phases, respectively.

8. The touch screen of claim 7, wherein the TX electrode substrate is patterned with a plurality of TX electrode lines coupled to receive the TX driving signals.

9. The touch screen of claim 8, wherein the RX electrode substrate is patterned with a plurality of RX electrode lines coupled to the RX detection unit.

10. The touch screen of claim 7, wherein the TX driving signals of all periods have a same overall DC value.

11. The touch screen of claim 7, wherein the TX driving signals of each period have a non-zero overall DC value.

12. The touch screen of claim 7, wherein the TX driving unit comprises:
means for coupling to a high voltage;
means for coupling to a low voltage;
a first switch, via which the high voltage is controllably outputted as the TX driving signal; and
a second switch, via which the low voltage is controllably outputted as the TX driving signal;
wherein the first switch and the second switch are controlled by a switching control signal and an inverted switching control signal, respectively, such that the TX driving signal is obtained by alternately coupling to the high voltage and the low voltage via the first switch and the second switch, respectively.
